(19) United States
(12) Patent Application Publication
(10) Pub. No.: US 2025/0369450 A1
(43) Pub. Date: Dec. 4, 2025

(54) METHOD FOR A VACUUM PUMP SYSTEM

(71) Applicant: Leybold GmBH, Cologne (DE)

(72) Inventor: Bruno Schwizer, Cologne (DE)

(21) Appl. No.: 18/877,154

(22) PCT Filed: Sep. 28, 2023
(86) PCT No.: PCT/EP2023/076960

§ 371 Date: Dec. 19, 2024

(30) Foreign Application Priority Data
Sep. 28, 2022 (GB) 2214193.1

(51) Int. Cl. F04D 27/00; F04D 19/04; G05B 15/02

(52) U.S. Cl. CPC F04D 27/00; F04D 19/04; G05B 15/02

(57) ABSTRACT

Method for determining a service event of a vacuum pump with the steps: Acquiring one or more pump parameters from the vacuum pump by a control unit of the vacuum pump; Transmitting, by the control unit, the one or more pump parameters to the cloud server; Determining, by the cloud server, one or more service events for the vacuum pump on the basis of the one or more pump parameters, where-in determining the service event is performed by a look-up table stored in the cloud server comprising a correspondence between the one or more pump parameters and the service event.

This application is a national stage entry under 35 U.S.C. § 371 of International Application No. PCT/EP2023/076960, filed Sep. 28, 2023, which claims the benefit of GB Application No. 2214193.1, filed Sep. 28, 2022, the entire contents of each of which are incorporated herein by reference.

### TECHNICAL FIELD

The present disclosure relates to a method for operating a vacuum pump system to determine a service event of the vacuum pump, such a vacuum pump, and a cloud server implementing steps of the method. Further, the present invention relates a vacuum pump system including at least one vacuum pump and a cloud server. Further, the present disclosure relates to a computer program storage device.

### SUMMARY

Vacuum pumps are used in numerous different technical fields in different locations around the world by different customers and their individual processes. Therein, reliable operation of the vacuum pump is crucial for these processes and failure of vacuum pumps may have tremendous monetary impact. Thus, the customer may stick to a maintenance schedule of the vacuum pump. Therein, in the prior art maintenance is scheduled regularly irrespective of the specific circumstances in which the vacuum pump is used. This may create unnecessary costs and burden for the customer since necessary maintenance of the vacuum pump may depend on the specific use of the vacuum pump and longer service intervals may be possible without the risk of failure.

Thus, it is an object of the present disclosure to determine service events more flexibly.

The problem is solved by a method according to claim 1, a vacuum pump according to claim 9, a cloud server according to claim 10, a system according to claim 11, and a computer program storage device according to claim 12.

In an aspect of the present disclosure a method for a vacuum pump system, including at least one vacuum pump and at least one cloud server, for determining a service event of the at least one vacuum pump is provided. The method comprises the steps of:
Acquiring one or more pump parameters from the vacuum pump by a control unit of the vacuum pump;
Transmitting, by the control unit, the one or more pump parameters to the cloud server;
Determining, by the cloud server, one or more service events for the vacuum pump on the basis of the one or more pump parameters, wherein determining the service event is performed by a look-up table stored in the cloud server comprising a correspondence between the one or more pump parameters and the service event.

Therein, a service event or a maintenance schedule event is indicating an upcoming need for a service of the vacuum pump. In particular, the cloud server is determining a plurality of different service events, wherein the different service events may relate to different service/maintenance tasks to be performed such as oil change, gear control/change, bearing control/change, drivebelt control/change or the like. In order to determine such service event, pump parameters from the vacuum pump are acquired by the control unit of the vacuum pump. These pump parameters are transmitted via a gateway or controller to the cloud server. The cloud server is a remote server which is located at a different location than the vacuum pump. The vacuum pump may be located at a customer, wherein the cloud server may be located at the manufacturer or a service provider providing the cloud server. Vacuum pump and cloud server are connected via a wireless area network (WAN) or local area network (LAN) or cellular internet via SIM card, i.e. the internet. The transmitted pump parameter is looked-up by the cloud server in a stored look-up table in order to determine the service event. Therein, the look-up table may indicate a time from the last service to the next service for the respective pump parameter, i.e. a service interval. The look-up table is used as a template to indicate safe and reasonable service intervals for a plurality of different pump parameters of the vacuum pump. By the service interval and the time since the last maintenance or service of the vacuum pump, the upcoming service event can be determined. For determining the service event all transmitted pump parameter can be used. Alternatively, one or a subset of the transmitted pump parameter can be used to be looked up in the look-up table.

Thereby, the time between two services of the vacuum pump can be calculated flexibly on the basis of the pump parameter. The look-up table provides an easy way to implement such calculation. Thus, the maintenance intervals can be determined by the cloud server in a more flexible way avoiding unnecessary services of the vacuum pump, thereby reducing the costs and burden to the costumer.

Preferably, the pump parameter includes one or more of an oil type, a process parameter, a maintenance contract information, a pump model, a pump serial number, a customer name, a location, a failure/warning register, a current of the vacuum pump, a frequency of the vacuum pump, a running time, and number of restarts.

It has been shown that for different oil types the service intervals can be prolonged and for some oil types even there is no need for an oil change on a regular basis. Thus, for specific oil types the service intervals can be determined more flexibly.

Further, it has been noted that a different use or a different process operated with the vacuum pump has an influence on the necessity to service the vacuum pump. For example, use in a harsh environment, such as used to pump gaseous chemicals or water, degradation of the oil and/or parts of the vacuum pump may be accelerated increasing the necessity of shorter service intervals. Therein, the pump process may include different stages, such as high, medium and low harsh process. More and/or different parametrizations of the process into the process parameter can be implemented.

The warning/failure register may include a storage of warnings and/or failures of the vacuum pump occurred in the past. The warnings and/or failures may be stored and transmitted as pump parameter. For example, if a temperature exceeds a certain threshold, this may be stored in the warning/failure register and may indicate the necessity of an imminent service.

The current of the vacuum pump may be an actual current of the vacuum pump or the current over time of the vacuum pump. Similarly, the frequency may be an actual frequency or rotating speed of the vacuum pump or the frequency over time. Current over time and/or frequency over time may be stored in the control unit.

The running time indicates an hour count of hours the pump is operating and running.

The number of restarts indicate the number of restarts of the control unit and/or the vacuum pump itself.

Preferably, the one or more pump parameters of a plurality of vacuum pumps are transmitted to the cloud server. Thus, one cloud server receives the pump parameters of a plurality of vacuum pumps, wherein the one cloud server determines the service events for each of the vacuum pumps.

Preferably, if the one or more pump parameters of a plurality of vacuum pumps are transmitted to the cloud server, transmission can be performed via different gateways, such that at least two vacuum pumps transmit their pump parameters via a different transmission channel or gateway (such as WAN, LAN, cellular connection or the like). Alternatively, transmission of all vacuum pumps is performed via the same or similar transmission channel or kind of gateway.

Preferably, one or more pump parameters is received from an external database such as an SAP-service or the like, or stored in the cloud server. Therein, for example maintenance contract information, customer, location or the like may be received not directly from the control unit itself but may be provided by an external database or may be stored in the cloud server and used to determine the service events.

Preferably, the cloud server stores a look-up table for each pump model. Since different pump models may include different services and in particular different service intervals, for each pump model a different look-up table can be provided and stored in the cloud server. Thus, upon determining by the cloud server the one or more service events for the specific model of the vacuum pump the respective look-up table is used.

Preferably, for different pump parameters different look-up tables may be stored in the cloud server. Thus, for pump parameters having influence on the service intervals, different look-up tables can be used when determining the service events. Thus, the pump parameter can not only be used to be looked-up in the look-up table, but can at the same time used to determine which look-up table is to be used. For example, the pump parameter of the location may be used to distinguish service intervals for different locations. Thus, for the pump parameter of the location, different look-up tables could be used, such as different look-up tables for different geographical regions such as different countries or different continents. Other examples include the use of different look-up tables for different maintenance contract information, pump models as mentioned before, customers, process parameter, oil types, pump parts such as bearings, cooling components, or the like.

Preferably, in the cloud server a hierarchy tree-structure is defined, wherein each vacuum pump is assigned to a leaf node of the hierarchy tree-structure. Therein, the hierarchy tree structure comprises a root node on the highest level of the hierarchy tree-structure, wherein to the root node several child nodes are connected in a first level. To each child node in the first level further nodes may be connected in a second level which are child nodes of the nodes in the first level. The nodes on the lowest level are referred to as leaf nodes corresponding to the respective vacuum pumps. Sub-nodes of a specific node indicate all nodes connected to the specific node on lower levels in the tree structure down to the leaf nodes. Each level may correspond to one of the pump parameters such that different vacuum pumps comprising the same pump parameter are sub-nodes to the same node, i.e. share the same parent node. A look-up table may be assigned to one or more of the nodes of the tree-structure. Sub-nodes of this node may use the same look-up table. In other words, all vacuum pumps directly connected to the node to which the look-up table is assigned may use this look-up table. Thus, it is possible to define look-up tables for respective subsets of vacuum pumps including those vacuum pumps sharing at least one common pump parameter such that they are sub-nodes of the node corresponding to this respective pump parameter. Hence, it is not necessary anymore to define a look-up table for each vacuum pump. At the same time, flexibility is achieved by the ability to assign different look-up tables to the respective nodes of the tree structure.

Preferably, different look-up tables are assigned to different nodes of the tree structure, wherein for a specific vacuum pump the look-up table is used which is assigned to the lowest level node in the tree structure connected to the specific vacuum pump. Thus, then starting from the leaf node of the tree structure corresponding to the specific vacuum pump and going back towards the root of the tree structure that look-up table is used which is found first.

Preferably, the determined one or more service events are displayed on a terminal preferably via a web interface. Therein, the terminal relates to a laptop, personal computer, smartphone, a tablet or the like.

Preferably, the determined one or more service events are transmitted to the control unit of the vacuum pump and preferably displayed by the control unit. Thus, the service events are also stored at the vacuum pump and may be displayed for information to the customer. Any stored service events being stored on the control unit of the vacuum pump may be overridden to be synchronized to the service events of the cloud server.

Thus, consistent service events are shown on the vacuum pump. At the same time, flexible adaption of the service events is possible even though service events are stored on the vacuum pump itself.

Preferably, the method further includes the step of performing a service according to the determined service event.

In another aspect of the present disclosure, a vacuum pump is provided comprising a control unit. The control unit is part of the vacuum pump and might be directly connected or integrally built with the vacuum pump. The control unit is configured to perform the respective steps of the method as described above. In particular, the control unit is configured to acquire one or more pump parameters from the vacuum pump and transmit these pump parameters to a cloud server via gateway for determining the service events.

Preferably, the control unit is configured to receive service events determined by a cloud server according to the method described above and may be configured to display these service events.

In another aspect of the present disclosure a cloud server is provided. The cloud server is configured to perform the respective steps of the method described before. In particular, the cloud server is configured to receive pump one or more parameters of one or more vacuum pumps and determine one or more service events for the vacuum pumps on the basis of the pump parameters, wherein determining the service events is performed by a look-up table stored in the cloud server comprising a correspondence between the pump parameters and the service events.

Preferably, the cloud server is further built along with the features described with respect to the method described above.

In another aspect of the present disclosure a system is provided comprising a vacuum pump or a plurality of vacuum pumps and a cloud server as described before.

In another aspect of the present disclosure a computer program storage device is provided storing instructions which when executed by a processor perform the respective steps of the method described above.

In particular, the instructions stored on the computer program storage device are executed by a processor of the cloud server for determining one or more service events for the vacuum pump on the basis of the received pump parameters, wherein determining the service events is performed by a look-up table stored in the cloud server comprising a correspondence between the pump parameter and the service event. Alternatively, the look-up table is stored on the same computer program storage device.

### BRIEF DESCRIPTION OF DRAWINGS

The present disclosure is described in more detail with reference to the accompanying figures.

The figures show:

FIG. 1 a schematic flow diagram of the method according to the present disclosure.

FIG. 2 a system according to the present disclosure.

FIG. 3 an example of a tree-structure according to the present disclosure.

FIG. 4 an example of a service event table.

### DETAILED DESCRIPTION

Referring to FIG. 1. FIG. 1 shows the steps of the method according to the present disclosure with the steps:

In step S01, acquiring one or more pump parameters from the vacuum pump by a control unit of the vacuum pump.

In step S02, transmitting, by the control unit, the one or more pump parameters to the cloud server.

In step S03, determining, by the cloud server, one or more service events for the vacuum pump on the basis of the one or more pump parameters, wherein determining the service event is performed by a look-up table stored in the cloud server comprising a correspondence between the one or more pump parameters and the service event.

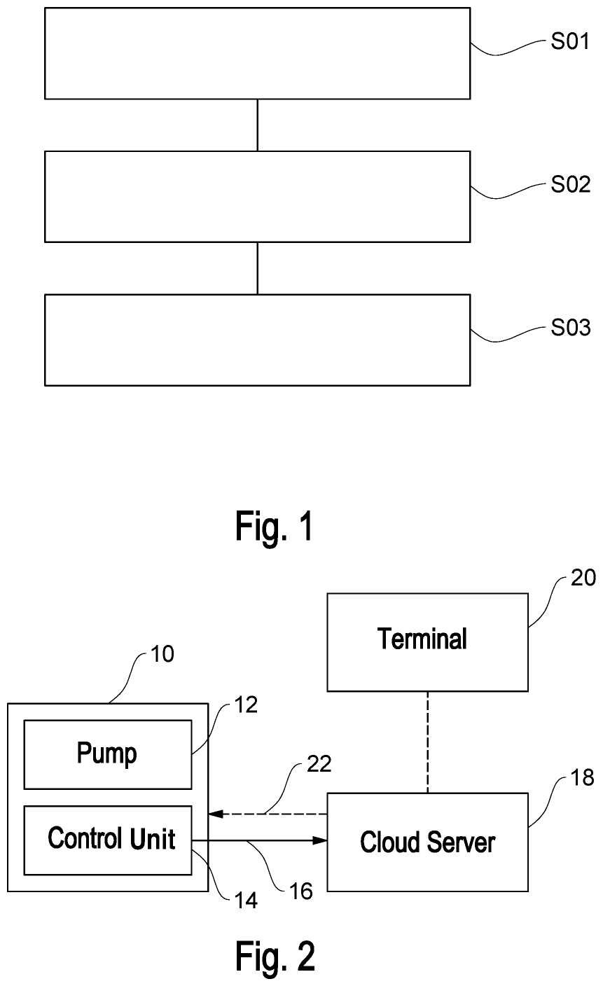

Referring to FIG. 2, a vacuum pump 10 comprises a pump mechanism 12 in order to pump a gaseous medium. The vacuum pump 10 comprises a control unit 14 in order to control operation of the pump mechanism 12. The control unit 14 may be directly connected to the pump mechanism 12 or may be provided as standalone unit directly connected to the pump mechanism 12. The control unit 14, according to step S01 of the present disclosure, acquires pump parameters from the vacuum pump and transmits these pump parameters via a cellular gateway or LAN/WAN 16 to a remote cloud server 18. The pump parameters may comprise one or more of:
an oil type,
process parameter,
maintenance contract information,
pump model,
pump serial number,
customer name,
alarm register,
current,
frequency,
running time.
number of restarts
serviced by partner (end customer, OEM, etc)

Preferably, the pump parameters include the pump serial number, which also may indicate the pump model, the oil type, maintenance contract information such as the party responsible for services or carrying out the service, and the running time.

Pump parameters may be transmitted to the cloud server 18 regularly. Therein, the pump parameters may by transmitted every 5 seconds, preferably every hour and more preferably once per day. Thereby transmitting intervals may depend on transmitted pump parameter such that dynamic pump parameters (e.g. current) may be transmitted more often (up to every 5 seconds) while other more static information (serial number) may be transmitted less regularly (daily). In the cloud server 18 a look-up table or template is stored, wherein one or more of the pump parameters are looked up in the look-up table and the look-up table provides corresponding service events or service intervals for the respective pump parameter or combination of pump parameters. Thus, for determining the service events all transmitted pump parameter can be used. Alternatively, one or a subset of the transmitted pump parameter may be used to be looked up in the look-up table. Thus, there is no need for an individual calculation of service events or service intervals. Instead, the look-up table provides an easy way for determining the upcoming service events. Therein, the cloud server 18 may receive the pump parameters from a plurality of different pumps 10, wherein the service events of the different vacuum pumps 10 are determined by the same look-up table. Hence, changing the look-up table or template in the cloud server 18, at the same time consistently changes the service events or service intervals for all of the connected vacuum pumps. Alternatively, the cloud server may store different look-up tables such that tailored service events can be determined for different sets of vacuum pumps.

The cloud server 18 may be accessible via a terminal 20, in particular via a web interface showing the determined service events. An example is depicted in FIG. 4 showing for specific serial number of a vacuum pump different kinds of services indicated as “Service A” and “Service B”. Further, the overall service interval is indicated for “Service A” with 3000 h running time and in the example for “Service B” with 10000 h running time. Further, the service event table of FIG. 4 shows the remaining running hours of the vacuum pump until the next service of the respective service type becomes due. For example, “Service A” may relate to an oil change, wherein a “Service B” relates to an overhaul of the vacuum pump. For certain types of oils used in vacuum pumps an oil change is not necessary and thus the “Service A” could be avoided in the example. This can be dynamically stored and the upcoming service events can be adapted accordingly.

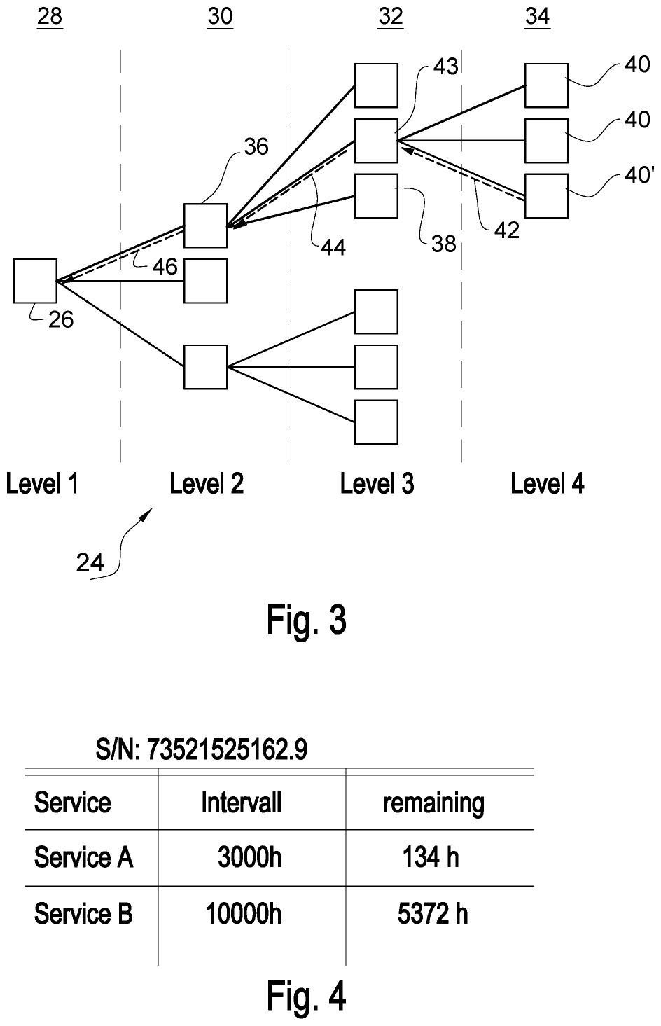

Referring to FIG. 3. The cloud server stores a hierarchy tree structure 24 exemplified in FIG. 3. The tree structure 24 has a root node 26 in a highest level 28 indicated as “Level 1”, wherein all nodes of the tree structure 24 are ordered in different levels 30, 32, 34 from the highest “Level 1” (first level) to the lowest “Level 4” (fourth level) in the example of FIG. 3. The tree structure 24 further comprises leaf nodes 40, 40′ in the lowest level 34, wherein each leaf node 40, 40′ correspond to a respective vacuum pump connected to the cloud server 18. To the root node 26 child nodes 36 are connected in the subsequent lower level 30. To each node in the second level 30, further child nodes 38 are connected and so on. For simplicity and representation, the root structure as shown in FIG. 3 does not show all nodes connected to the individual nodes of the higher level. Further, the example of FIG. 3 must not be understood in a limiting way. The tree-structure stored in the cloud server may have more or fewer levels and more or fewer nodes. In particular, it is shown in FIG. 3 that each parent node has three child nodes which might be different in the tree-structure stored in the cloud server 18.

Therein, sub-nodes of node 36 in the second level 30 correspond to all nodes connected to node 36 in lower levels, i. e. “Level 3” and “Level 4” in the example of FIG. 3. To each of the nodes of the tree structure 24 a specific look-up table can be assigned. Therein, all sub-nodes of the node to which the look-up table is assigned use the same (if not replaced by a look-up table assigned to one of the sub-nodes itself and as explained in more detail hereinafter). Therein, each level may correspond to a specific pump parameter. For example, the nodes 36 of the second level 30 may correspond to different locations of the respective vacuum pumps. Thus, each vacuum pump connected to the node 36 may refer to vacuum pumps located in a specific country. Thus, for example further conditions or specific legal specifications of this country can be covered by a respective look-up table assigned to node 36. For example, the node 36 can correspond to a northern location such that the vacuum pump exhibits lower temperatures. Alternatively, for example the node 36 corresponds to a location with increased dust such that the respective vacuum pumps 40, 40′ suffer from this dust, which may include shorter service intervals. In order to determine the valid look-up table, it is started from a respective vacuum pump 40′ and from there going back to the higher level as indicated by arrow 42. If a look-up table is assigned to the node 43, vacuum pump 40′ uses the look-up table assigned to node 43. If no look-up table is assigned to the node 43 of the third level 32, it is going back further as indicated by arrow 44 to the node 36 of the second level 30. If a look-up table is assigned to node 36 of level 2 for the specific vacuum pump 40′ the look-up table is used. If no look-up table is assigned to the node 36 of the second level 30, it is further going back according to arrow 46 to the root node 26 using the look-up table assigned to the root node 26. Of course, service events can be changed manually for specific vacuum pumps.

Hence, a flexible way for managing service intervals and service events for a plurality of vacuum pumps is provided. In particular, it is only necessary to define look-up tables or templates for specific sub-set of vacuum pumps. Therein, all these vacuum pumps of the subset can use the same look-up table. For different sub-sets different look-up tables can be used, wherein the vacuum pumps can be ordered in a tree structure in order to organize the respective look-up tables and the subsets of vacuum pumps.

1. A method for a vacuum pump system, including at least one vacuum pump and at least one cloud server, for determining a service event of the at least one vacuum pump with the steps:
acquiring one or more pump parameters from the vacuum pump by a control unit of the vacuum pump;
transmitting, by the control unit, the one or more pump parameters to the cloud server; and
determining, by the cloud server, one or more service events for the vacuum pump on the basis of the one or more pump parameters, wherein determining the service event is performed by a look-up table stored in the cloud server comprising a correspondence between the one or more pump parameters and the service event.

2. The method according to claim 1, wherein the pump parameter includes one or more of an oil type, process parameter, maintenance contract information, pump model, pump serial number, customer name, location, alarm register, current, frequency, running time, number of restarts.

3. The method according to claim 1, wherein pump parameters of a plurality of vacuum pumps are transmitted to the cloud server.

4. The method according to claim 1, wherein the cloud server stores a look-up table for each pump model.

5. The method according to claim 1, wherein in the cloud server a tree-structure is defined, wherein each vacuum pump is assigned to a leaf node of the tree-structure, wherein each level of the tree structure may correspond to one of the pump parameters such that different vacuum pumps comprising the same pump parameter share the same parent node, wherein a look-up table is assigned to one of the nodes of the tree-structure, wherein all sub-nodes of this node use the same look-up table.

6. The method according to claim 5, wherein different look-up tables are assigned to different nodes of the tree-structure, wherein for a specific vacuum pump the look-up table is used which is assigned to a lowest level node in the tree-structure connected to the specific vacuum pump.

7. The method according to claim 1, wherein the determined one or more service events are displayed on a terminal, preferably via a web interface.

8. The method according to claim 1, wherein the determined one or more service events are transmitted to the control unit of the vacuum pump and preferably displayed by the control unit.

9. A vacuum pump comprising a control unit being configured to perform the respective steps of the method according to claim 1.

10. A cloud server configured to perform the respective steps of the method according to claim 1.

11. A system comprising one or more vacuum pumps, wherein each vacuum pump having a control unit, and a cloud server, wherein the control unit and the could server are configured to perform the steps of the method according to claim 1.

12. A computer program storage device storing instructions which when executed by a processor perform the respective steps of the method according to claim 1.
